(19) United States
(12) Patent Application Publication
(10) Pub. No.: US 2013/0313496 A1
(43) Pub. Date: Nov. 28, 2013

(54) Multi-Functional Electric Winch

(71) Applicant: Mingkui Zheng, Ningbo City (CN)

(72) Inventor: Mingkui Zheng, Ningbo City (CN)

(21) Appl. No.: 13/569,996

(22) Filed: Aug. 8, 2012

(30) Foreign Application Priority Data
May 25, 2012 (CN) 201210171735.1

(51) Int. Cl. B66D 1/12

(52) U.S. Cl. CPC B66D 1/12
USPC 254/362

(57) ABSTRACT

The disclosure provides a multi-functional electric winch that includes an electric motor, a winch and functional units. A first connection member is mounted to each functional unit and a second connection member is mounted to an end of electric motor. The first connection member has connection openings sequentially arranged in a circumferential direction of an input shaft of the functional unit, while the second connection member has projections that are able to be inserted into the connection openings and engaged therein by screwing. The connection openings includes first portions for the projections to be inserted, and second portions for seating and limiting the projections in axial and circumferential direction, wherein the first portions communicate with the second portions. The input shaft of each functional unit is provided with a hole, to which a rotatable shaft of the electric motor is connectable and which has a cross section of polygon.

### TECHNICAL FIELD

The present invention relates to a technical field of an electric winch, more particularly, to a multi-functional electric winch.

### BACKGROUND ART

Presently, a multi-functional electric winch generally includes an electric motor, a winch, a clutch and functional units. The electric motor is used to drive the winch. The clutch is used to control the engagement and disengagement of the winch to the electric motor. The functional units are detachably mounted to the electric motor. Although this multi-functional electric winch breaks through the limitation of a traditional electric winch, the structure of the detachable connection of the functional units to the electric motor is so complicated that connection between them would not be quick enough.

### SUMMARY OF THE INVENTION

The technical problem to be solved of the present invention is to provide a multi-functional electric winch in which the structure of the detachable connection of the functional units to the electric motor is simple and thus quick connection can be achieved.

The technical solution of the invention is to provide a multi-functional electric winch, which includes an electric motor, a winch, a clutch and functional units, and further includes a first connection member and a second connection member; the first connection member is mounted to each functional unit and the second connection member is mounted to an end of electric motor, or the second connection member is mounted to each functional unit and the first connection member is mounted to an end of the electric motor; the first connection member has connection openings that are sequentially arranged in a circumferential direction of an input shaft of the functional unit, while the second connection member has projections that are able to be inserted into the connection openings and engaged therein by screwing; the connection openings includes first portions for the projections to be inserted, and second portions for seating and limiting the projections in axial and circumferential direction, wherein the first portions connect with the second portions; the input shaft of each functional unit is provided with a hole, to which a rotatable shaft of the electric motor is connectable and which has a cross section of polygon, or the input shaft of each functional unit is provided with a shaft, which has a cross section of polygon and which is connectable to a polygonal hole arranged on a rotatable shaft of the electric motor.

The principles of the invention are as follow: when attaching or replacing functional units, the quick engagement of the first connection member to the second connection member can be accomplished by engagement of the connection openings with the projections, such that the quick engagement of functional units to the electric winch can be achieved; meanwhile, the quick engagement of input shaft of functional units to the rotatable shaft of the electric motor can be accomplished by engagement of a polygonal hole with a shaft.

With the structure, compared with the existing technology, the present invention has the following advantages: from above-mentioned technical solution and operating principles, mutual cooperation among elements can achieve a simple structure of the detachable connection of the functional units to the electric motor and quick connection. In addition, according to the invention, fewer parts are used and the connection relations are simple. Thereby the invention has an obvious advantage of simple struction.

As a modification, the second connection member is bolts, the first portions are round holes for heads and stems of the bolts to be inserted, and the second portions are arc-shaped holes for limiting the bolt heads in axial direction and sliding the bolt stems to its stop end to restrain the bolts in circumferential direction. This structure is simple and compact, connection reliable and cost for manufacture low, thus facilitating the improvement on the performance of the invention and the implementation.

As another modification, the second portion is provided with a restraining element (8) that is used to prevent the projections, which have engaged and seated by screwing, from reversely rotating in circumferential direction. This structure can enhance the restraint effect in circumferential direction, and prevent from reversely rotating due to a great torque when functional unit is at work.

As a further modification, one of the functional units is protective cap. Owing to the compact structure and the light weight of the protective cap, while protective effect (on the one hand, the rotatable shaft of the electric motor and the inner of the electric motor can be protected by the cap; on the other hand, other functional units which are temporarily idle can be protectively in storage rather than attached to the electric motor) functions, the cap may provide conveniences for user, i.e., the functional units can be configured as required. For example, a user would only buy a multi-functional electric winch with a protective cap at first when he does not need additional functions; when washing function is needed, then he shall simply buy a water pump with the first connection member to achieve a function of washing.

### DESCRIPTION OF FIGURES

FIG. 1 is an exemplary structural view of a multi-functional electric winch according to the present invention;

FIG. 2 is an exemplary structural view of the multi-functional electric winch according to the present invention with functional units removed;

FIG. 3 is an exemplary structural view of a protective cap of the multi-functional electric winch according to the present invention;

FIG. 4 is an exemplary structural view of an inflator pump of the multi-functional electric winch according to the present invention;

FIG. 5 is an exemplary structural view of a water pump of the multi-functional electric winch according to the present invention;

FIG. 6 is an exemplary structural view of an air pump with a shift gear of the multi-functional electric winch according to the present invention.

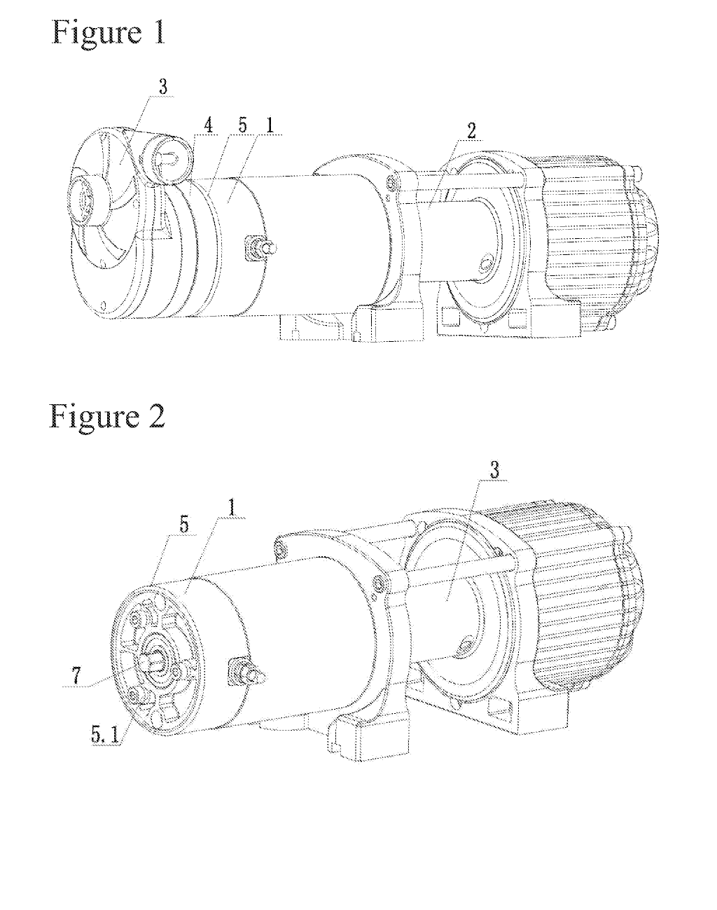

### LIST OF REFERENCE NUMERAL

1 indicates an electric motor, 2 indicates a winch, 3 indicates a functional unit, 3.1 indicates an input shaft, 4 indicates a first connection member, 4.1 indicates connection openings, 4.1.1 indicates first portions, 4.1.2 indicates second portions, 5 indicates a second connection member, 5.1 indicates projections, 6 indicates a hole, 7 indicates a rotatable shaft, and 8 indicates a restraining element.

### MODE OF CARRYING OUT THE INVENTION

The details of the present invention are set forth in the accompanying drawings below.

A multi-functional electric winch of the present invention includes an electric motor 1, a winch 2, a clutch and functional units 3, and further includes a first connection member 4 and a second connection member 5. The first connection member 4 is mounted to each functional unit 3 and the second connection member 5 is mounted to an end of electric motor 1. Alternatively, the second connection member 5 is mounted to each functional unit 3 and the first connection member 4 is mounted to an end of the electric motor 1. The first connection member 4 has connection openings 4.1 that are sequentially arranged in a circumferential direction of an input shaft 3.1 of the functional unit 3. Accordingly, the second connection member 5 has projections 5.1 that are able to be inserted into the connection openings 4.1 and engaged therein by screwing. The connection openings 4.1 includes first portions 4.1.1 for the projections 5.1 to be inserted, and second portions 4.1.2 for seating and limiting the projections 5.1 in axial and circumferential direction. The first portions 4.1.1 communicate with the second portions 4.1.2. The input shaft 3.1 of each functional unit 3 is provided with a hole 6, to which a rotatable shaft 7 of the electric motor 1 is connectable and which has a cross section of polygon. Alternatively, the input shaft 3.1 of each functional unit 3 is provided with a shaft, which has a cross section of polygon and which is connectable to a polygonal hole 6 arranged on a rotatable shaft 7 of the electric motor 1.

In this embodiment, the first connection member 4 is mounted to each functional unit 3 and the second connection member 5 is mounted to an end of the electric motor 1. There are three first connection members 4 and three second connection members 5. For the purpose of simple structure, the second connection members 5 are end caps of the electric motor 1. The input shaft 3.1 of each functional unit 3 is provided with the hole 6, to which the rotatable shaft 7 of the electric motor 1 is connectable and which has a cross section of polygon.

The second connection member 5 is bolts. The first portions 4.1.1 are round holes for heads and stems of the bolts to be inserted. The second portions 4.1.2 are arc-shaped holes for limiting the bolt heads in axial direction and sliding the bolt stems to its stop end to restrain the bolts in circumferential direction.

The second portions 4.1.2 is provided with a restraining element 8 that is used to prevent the projections 5.1, which have engaged and seated by screwing, from reversely rotating in circumferential direction. The restraining element 8 is a knob. A rod of the knob is screwed into a threaded hole on the first connection member 4. The rod may restrain the projection 5.1 in circumferential direction by screwing on. On the other hand, the rod may release the projection 5.1 so that it can reversely rotate in circumferential direction by screwing off.

One of the functional units 3 is protective cap.

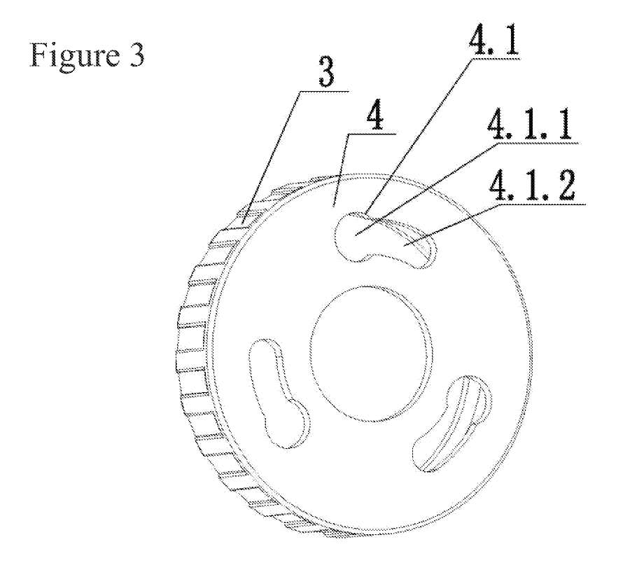

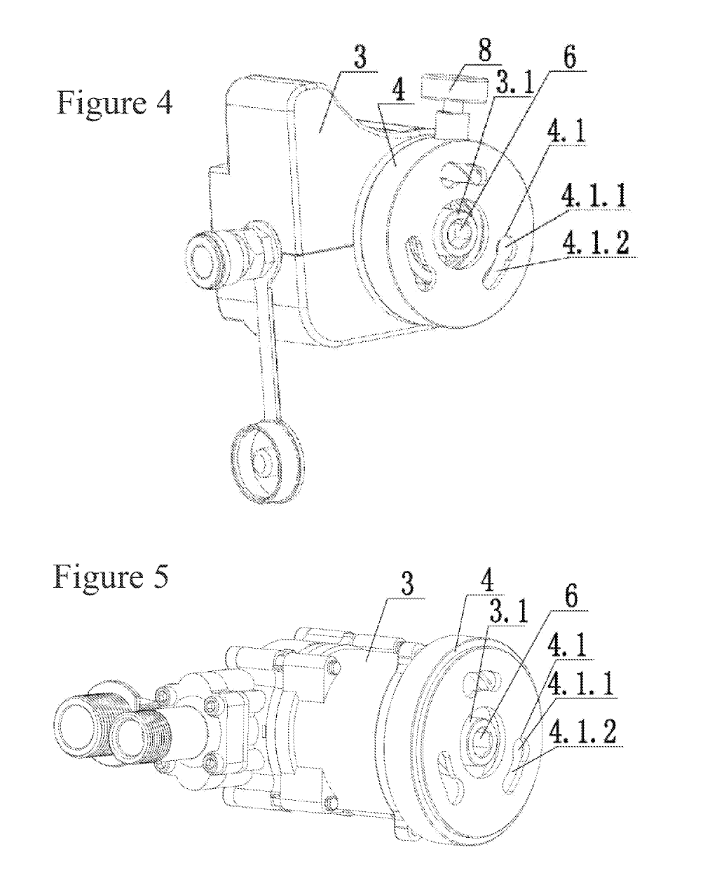

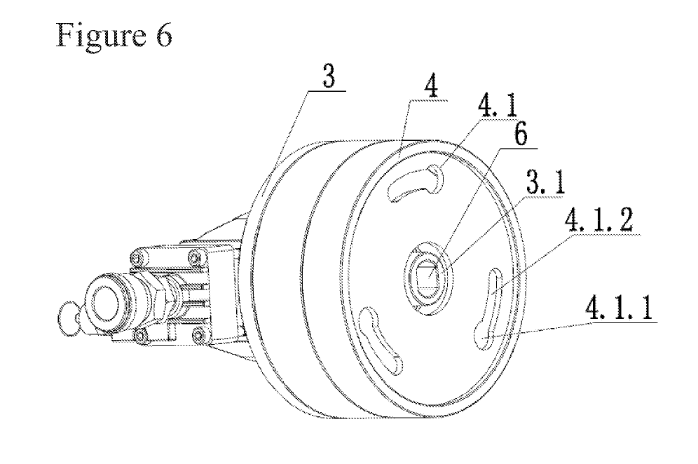

The functional units 3 shown in FIGS. 1 and 3-6 are a scavenge pump, a protective cap, an inflator pump, a water pump and an air pump with a shift gear, respectively. For water pump or air pump with a shift gear, the related input shaft 3.1 is an input part of the shift gear.

The first connection member 4 and the second connection member 5 are firmly fixed to the functional units 3 or the electric motor 1 by bolts.

1-4. (canceled)

5. A multi-functional electric winch comprising an electric motor, a winch, a clutch and functional units, the multi-functional electric winch further includes a first connection member and a second connection member; the first connection member is mounted to each functional unit and the second connection member is mounted to an end of electric motor, or the second connection member is mounted to each functional unit and the first connection member is mounted to an end of the electric motor; the first connection member has connection openings that are sequentially arranged in a circumferential direction of an input shaft of the functional unit, while the second connection member has projections that are able to be inserted into the connection openings and engaged therein by screwing; the connection openings include first portions for the projections to be inserted, and second portions for seating and limiting the projections in axial and circumferential direction, wherein the first portions communicate with the second portions; the input shaft of each functional unit is provided with a hole, to which a rotatable shaft of the electric motor is connectable and which has a cross section of polygon, or the input shaft of each functional unit is provided with a shaft, which has a cross section of polygon and which is connectable to a polygonal hole arranged on a rotatable shaft of the electric motor.

6. The multi-functional electric winch according to claim 5, wherein the second connection member has bolts, the first portions are round holes for heads and stems of the bolts to be inserted, and the second portions are arc-shaped holes for limiting the bolt heads in axial direction and sliding the bolt stems to its stop end to restrain the bolts in circumferential direction.

7. The multi-functional electric winch according to claim 5, wherein the second portions is provided with a restraining element that is used to prevent the projections, which have engaged and seated by screwing, from reversely rotating in circumferential direction.

8. The multi-functional electric winch according to claim 5, wherein one of the functional units is a protective cap.
